(19) United States
(12) Patent Application Publication
(10) Pub. No.: US 2007/0274840 A1
(43) Pub. Date: Nov. 29, 2007

(54) Magnetohydrodynamic pump

(76) Inventors: Thomas Ehben, Weisendorf (DE); Walter Gumbrecht, Herzogenaurach (DE); Sebastian Schmidt, Erlangen (DE); Christian Zilch, Leipzig (DE)

Correspondence Address: HARNESS, DICKEY & PIERCE, P.L.C., P.O.BOX 8910, RESTON, VA, 20195, US

(21) Appl. No.: 11/637,781

(22) Filed: Dec. 13, 2006

(30) Foreign Application Priority Data
Dec. 14, 2005 (DE) 10 2005 059 805.6

(51) Int. Cl. B60L 9/16

(52) U.S. Cl. 417/50; 310/11

(57) ABSTRACT

A MHD pump, in an example embodiment, includes a fluid channel, an electrode pair that generates an electric field in the fluid channel, and an electromagnet that generates a magnetic field, the magnetic field lines of which intersect the electric field lines of the electric field. The fluid channel is defined in an exchangeable cassette.

### PRIORITY STATEMENT

The present application hereby claims priority under 35 U.S.C. §119 on German patent application number DE 10 2005 059 805.6 filed Dec. 14, 2005, the entire contents of which is hereby incorporated herein by reference.

### FIELD

Embodiments of the invention relate to a magnetohydrodynamic pump. The magnetohydrodynamic pump is hereinafter referred to as a MHD pump.

### BACKGROUND

In medicine and in chemical and biological research, analytical studies are often instigated in which liquids are conducted through fluidic analysis systems. They here pass through various stations, in which they are manipulated or analyzed. For this, it is necessary that the liquids are moved through the fluidic channels at defined feed rates and flow rates.

In analyses which are regularly repeated, parts of the analytical systems are frequently combined into disposable components (“cartridges”). The test arrangement can be quickly and easily set up by changing the cartridge and the risk of carry-over from study to study is reduced. The transport of liquid within the cartridge proves difficult, however, since the fluidic channels contained therein are not accessible as a result of the encapsulation. Miniaturized pumps integrated in the cartridge are certainly theoretically possible, but they are complex to produce and would excessively increase the manufacturing costs for the cartridge.

In general, the controlled transport of liquid within the cartridge is achieved by the installation of one or more pumps in that part of the analysis system which is to be repeatedly used (“evaluation apparatus”), which pump(s) pump liquids through the cartridge from outside. The liquids in question are generally water or aqueous solutions. As the pumps, piston, diaphragm or hose pumps may be considered. They are not integrated in the cartridge as they are complex and expensive and, as a result of their dimensions, would have a negative impact upon the size of the cartridge. At the fluidic interface(s) between evaluation apparatus and cartridge, the problem of carry-over remains. Further problems in connection with pumps outside the cartridge derive from the increased dead volume resulting from the relatively large pump volumes and the supply lines, whereby an unnecessarily large amount of solution is used and can spoil as a result of lengthy residence in the pump and supply line system. Moreover, elasticities in pumps and supply lines make the precise metering and control of the fluidic propulsion more difficult.

Another known process is that of electroosmosis, in which a voltage is applied to the liquid channel in such a way that the electric field points in the direction of the desired movement. This results in a movement of the ions contained in the liquid (electrophoresis), which ions, due to the osmotic effect, drag the water after them. This process is beset, however, with a number of problems: In order to achieve an acceptable field strength, a high voltage is necessary and the current always flows in the same direction, so that ions are deposited on the electrodes, which changes the composition of the solution. On the other hand, the oppositely directed movements of anions and cations can cancel each other out, so that the movement of the liquid is restricted.

US 2002/0137196 A1 proposes a microchip on which, in addition to various analysis devices, a plurality of MHD pumps are disposed.

A MHD pump according to the prior art, as it is shown in FIG. 5, generally has a fluid channel 1, an electrode pair 2 that generates an electric field in the fluid channel, and an electromagnet 3 that generates a magnetic field, the magnetic field lines of which intersect the electric field lines of the electric field. On two opposite walls of the fluid channel 1, which is filled fully with solution, i.e. such that it is free from gas, the electrode pair 2 is brought into contact with a solution. To these electrodes 2, an alternating voltage is applied. As a result of this voltage, an alternating electric field is generated perpendicular to the channel direction, which makes the ions 100 contained in the solution oscillate back and forth transversely to the channel direction. Anions move to the respective cathode, cations move to the anode.

Disposed next to the channel 1 is an electromagnet 3 that generates a magnetic field perpendicular to the alternating electric field and to the channel direction. This particular magnetic field is also an alternating field, the frequency and phase of which is temporally correlated with the electric field, i.e. has the same frequency, for example, but can have different waveform and phase. Upon each transverse movement of the ions 100, they undergo according to the Lorentz law, as a result of the magnetic field, a mechanical acceleration in the channel direction. Overall, they thereby describe a zigzag movement along the channel 1. As a result of the gas-free filling of the channel 1, the solution cannot move transversely to the channel 1. However, it can be displaced in the channel direction. Since the ions are in homogeneous solution, they also drag with them in the channel direction, by virtue of their vectorial motional components, the uncharged constituent parts of the solution. The solution is thus moved forwards through the channel 1. Preferably, the magnetic field lines intersect the electric field lines at right angles to enable the Lorentz force to be seen to full effect.

This pump principle also works where the fluid channel is disposed horizontally and is only partially filled with liquid medium.

According to US 2002/0137196, a plurality of MDH pumps are disposed in a predetermined complex layout on the microchip, the electrodes being incorporated below the side walls of a silicon-glass composite and each pump being assigned to a corresponding analysis and function unit. The field of application of these microchips is predefined by the predetermined layout on the chip.

### SUMMARY

In at least one embodiment of the present invention, a magnetohydrodynamic pump is provided which can be used for any chosen fields of application.

According to at least one embodiment of the invention, it is proposed to provide a MHD pump which has a fluid channel, an electrode pair that generates an electric field in the fluid channel, and an electromagnet that generates a magnetic field, the magnetic field lines of which intersect the electric field lines of the electric field, the fluid channel being defined in an exchangeable cassette.

Advantageously, MHD pumps of this type, which are small and simple to make, can be used for an analysis system.

### BRIEF DESCRIPTION OF THE DRAWINGS

The invention is now described more closely on the basis of illustrative example embodiments with reference to the appended drawings, in which:

FIG. 1 shows a first illustrative embodiment of a MHD pump,

FIG. 2 shows a second illustrative embodiment of a MHD pump,

FIG. 3 shows a third illustrative embodiment of a MHD pump,

FIG. 4 shows a fourth illustrative embodiment of a MHD pump, and

FIG. 5 shows the basic working principle of a MHD pump,

FIG. 6 shows a top view of a fifth illustrative embodiment of a MHD pump, and

FIG. 7 shows the MHD pump of FIG. 6 in cross section.

### DETAILED DESCRIPTION OF THE EXAMPLE EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referencing the drawings, wherein like reference numerals designate identical or corresponding parts throughout the several views, example embodiments of the present patent application are hereafter described.

Example illustrative embodiments of the MHD pumps according to the invention are described below.

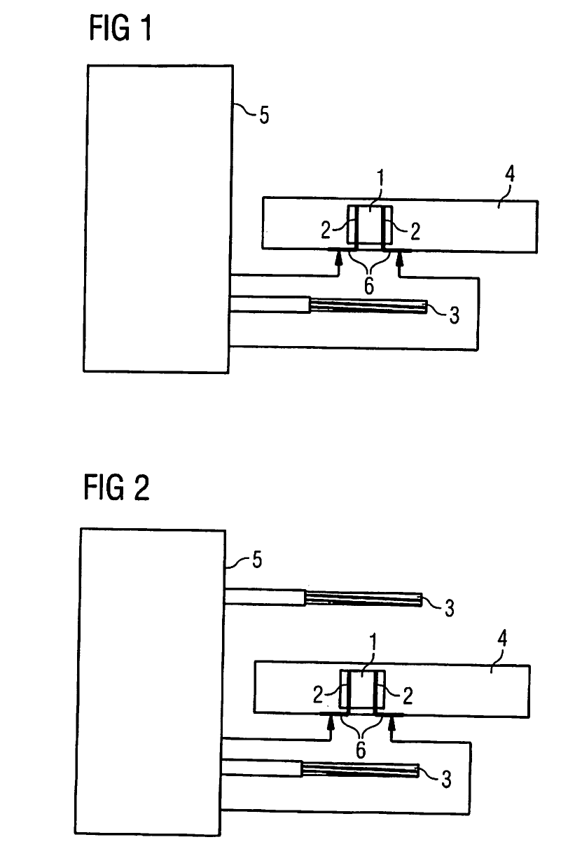

In FIG. 1, a first illustrative embodiment of a MHD pump is shown.

The MHD pump has a fluid channel 1, an electrode pair 2 that generates an electric field in the fluid channel 1, and an electromagnet 3 that generates a magnetic field, the magnetic field lines of which intersect the electric field lines of the electric field.

According to an example embodiment of the invention, the fluid channel 1 is defined in an exchangeable cassette 4. The exchangeable cassette 4 is formed from a suitable plastic. Preferably, the exchangeable cassette 4 is an injection molded part.

On the cassette 4 there are provided electrical contacts 6 for the electrode pair 2. Insofar as the exchangeable cassette 4 is configured as an injection molded part, the electrical contacts 6 are preferably inserts.

Outside the exchangeable cassette 4 there is disposed an electromagnet 3 in the form of a coil. The coil is supported on a holder 5, which further contains the electronics for generating the activating signals for the electrodes and the coil(s). The holder 5 additionally has electrical contacts 6, which are connectable to the electrical contacts 6 of the exchangeable cassette 4. Preferably, the holder 5 has a receiving fixture (not shown) for the exchangeable cassette 4, into which the exchangeable cassette 4 can be inserted such that the electrical contacts 6 of the exchangeable cassette 4 and of the holder are electrically connected to each other. At the same time, the fluid channel 1 is connected to corresponding fluid lines (not shown) of the holder 5, so that the MHD pump is actively installed in an evaluation or analysis system.

The MHD pump according to the first illustrative embodiment, having the exchangeable cassette 4, is advantageously distinguished by a modular construction and can be used in any chosen evaluation or analysis systems.

Advantageously, the MHD pump according to an example embodiment of the invention can be realized very easily. As a minimal intrusion into an existing fluidic architecture, all that is required is the introduction of two electrodes 2 into the fluidic medium. A very favorable apportionment of the necessary components to the exchangeable cassette 4 and to the evaluation and analysis system can be realized, in which only the electrodes 2 and the contacts 6 connected thereto are accommodated in the exchangeable cassette 4. The marginal costs which are thereby created are extremely small.

In connection with commonly used manufacturing processes for plastic parts in large batch numbers, especially by injection molding, the electrodes 2 and electrical contacts 6 can be realized in the simplest case as two sheet-metal parts. Cost-sensitive applications such as biochips in clinical diagnostics profit particularly from this simplicity.

In FIG. 2, a second illustrative embodiment of a MHD pump is shown.

The MHD pump according to the second illustrative embodiment is similar to the MHD pump of the first illustrative embodiment, with the addition of a second coil 3. According to the second illustrative embodiment, the electromagnet 3 consequently includes two coaxial coils 3, between which the fluid channel 1 is centrally disposed.

This coil arrangement is also referred to as a so-called Helmholtz coil, and it advantageously produces a particularly homogeneous magnetic field in the region between the two single coils 3. As a result, the distance of the coils 3 from the channel loses in importance and the coils 3 can be accommodated in the fluid channel 1 relatively far outside the exchangeable cassette 4 in the evaluation apparatus without adverse effects upon the magnetic field, whereby the MHD pump, in turn, can be made simpler and more cheaper.

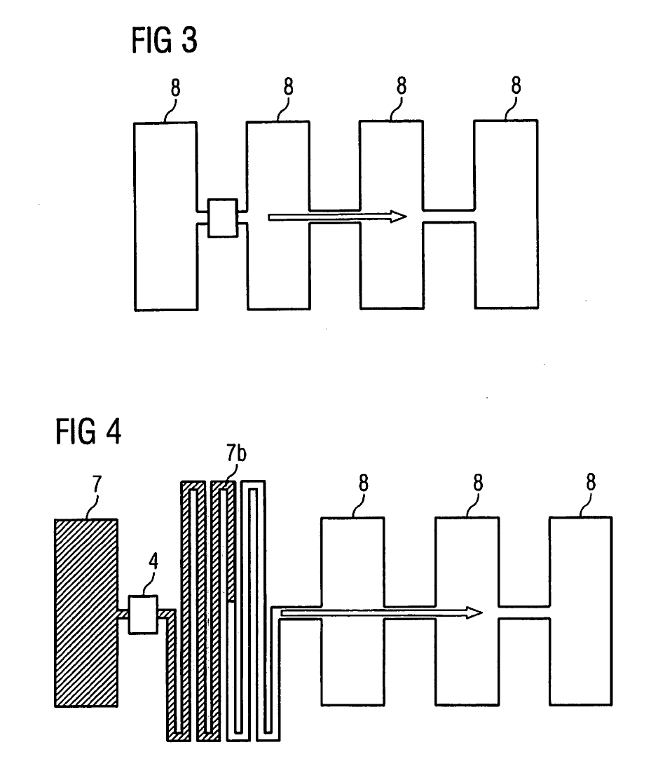

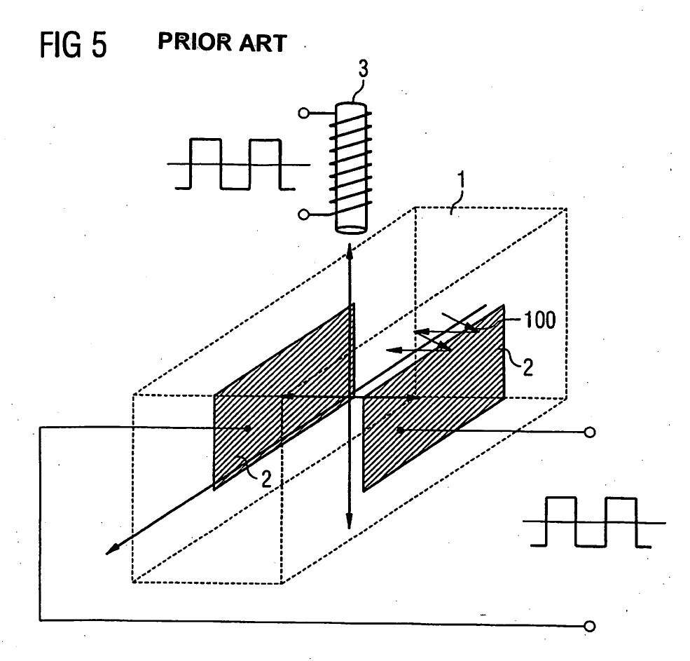

In FIG. 3, a third illustrative embodiment of a MHD pump is shown.

In this illustrative embodiment, a MHD pump is disposed at one or more points in the region of connecting channels between manipulation or analysis stations 8. Through the use of the modular, exchangeable cassettes 4, it is possible to produce various fluidic architectures. The exchangeable cassettes 4 are here disposed, according to requirement, between the corresponding manipulation and analysis stations 8.

Moreover, the ions present in the fluidic medium to be studied are advantageously used for propulsion purposes.

In FIG. 4, a fourth illustrative embodiment of a MHD pump is shown.

The MHD pump having the exchangeable cassette 4 is connected upstream to a fluid chamber 7 containing a pumping medium. In addition, the MHD pump is connected downstream to a fluid chamber 7b, likewise containing a pumping medium. The downstream fluid chamber forms a serpentine continuation 7b.

Connected downstream of the serpentine continuation 7b are a plurality of stations 8 of the analytical system 8. The pumping medium in the fluid channel 1 and in the fluid chamber 7, 7b of the MHD pump is in a fluid connection with the fluid to be pumped which is present in the stations 8.

Preferably, the pumping medium is an ion-containing liquid or a liquid metal such as, for example, mercury or galistan, an alloy of gallium, indium and tin.

The pumping medium of the MHD pump according to the fourth illustrative embodiment is located in a channel portion which is placed upstream of the other stations 8 of the analytical system, so that the driven liquid column of the pumping medium forces the fluid to be pumped through the stations 8 placed downstream.

This arrangement is advantageous, in particular, in cases in which the fluidic medium to be studied contains no or too few ions. In these, the pumping medium can be fully separated from the fluidic medium to be analyzed. The use of a suitable ion-containing liquid or of a liquid metal such as mercury, for example, ensures a reasonable pump throughput, and a single MHD pump is sufficient even in larger evaluation or analysis systems 8. A small channel cross section means that there can be no diffusion between the pumping medium and the fluid to be pumped. Where necessary, where large volumes are to be moved, the pumping section can be connected to elongated, thin channels of the analytical stations. A compact construction can here be achieved if these connecting channels are made serpentine.

For the separation of the two liquid phases, a piston, a ball, an organic separating medium, for example a resin or gum, or a gas can be enclosed in the fluid channel between the pumping medium and the fluidic medium to be analyzed. This prevents the analytes from being contaminated with the pumping medium, and vice versa.

In addition to the represented illustrative embodiment, manifold modifications are possible.

The third illustrative embodiment according to FIG. 3 can be modified such that the MHD pumps are disposed directly in one or more chambers 8 for manipulation or analysis. In this modification also, the ions present in the fluidic medium to be studied are advantageously used for propulsion purposes. Furthermore, besides the propulsion of the pumping medium, a generation of agitation effects by circular movements of the ions is also possible. For this, the electrode pair and the electromagnet are not acted upon synchronously, but with a phase angle of, for example, 90°. Within an oscillation period, both the transverse and the longitudinal movements of the ions in the channel cancel each other out, so that the fluidic medium is stimulated, but is not moved forwards. The fluidic medium could also be heated indirectly by particularly strong agitation movements. Such a heating could also be used to carry out a PCR (polymerase chain reaction).

The fourth illustrative embodiment according to FIG. 4 can be modified such that the MHD pump is disposed downstream of the stations 8 of the analytic system. The MHD pump is here disposed in a channel portion which is placed downstream of the other stations 8 of the analytical system. The driven liquid column sucks the fluidic medium through the stations 8 placed upstream. In front of the MHD pump, an intact liquid column must already be present in the fluidic system. Moreover, the propulsion in the pumping operation must not become so strong that the liquid column placed upstream of the MHD pump tears off as a result of the suction.

The first illustrative embodiment according to FIG. 1 can be modified such that the electrode pair 2, is also disposed outside the exchangeable cassette 4. In this case, the exchangeable cassette 4 has merely the fluid channel 1.

The first illustrative embodiment according to FIG. 1 can also be modified such that the electrode pair 2 and the electromagnet 3 are disposed within the exchangeable cassette 4. In this case, the whole of the MHD pump is integrated in an exchangeable cassette 4.

The MHD pumps of the above-described illustrative embodiments and the modifications thereof are further provided with a control device (not shown) for controlling the electrical voltages applied to the electrode pair 2 and to the electromagnet 3. The control device is preferably accommodated outside the exchangeable cassette 4 in the evaluation apparatus. Between the apparatus and the exchangeable cassette 4, merely two or four electrical contacts 6 are necessary as the interface, depending on whether the electrode pair 2 and the electromagnet 3 are integrated in the cassette 4.

Through a suitable activation of the electrical voltages for the electrode pair 2 and the electromagnet 3, various effects can be produced.

The working frequency of the pump should be chosen relatively high, for example greater than 1 kHz, preferably greater than 1 MHz, since the ions per oscillation period, as a result of the oscillating electric field, can perform only microscopically small movements in the transverse direction. The reason for this is the relaxation or electrophoretic effect: in a model-theoretical reflection according to Debye-Htickl, ions in solution are surrounded without external electric field by a cloud of ions of respectively different polarity. If the ions are separated from one another by an electric field, a local opposing field is formed between them. Consequently, the path lengths of the ion movements are limited. Just as small, therefore, is the forward movement of the ions in the channel direction, which movement is induced by magnetic field and Lorentz force. A high oscillation frequency compensates for the short distance covered by the ions per period.

A further reason for a high oscillation frequency is the prevention of ion deposits on the electrodes 2, which lead to undesirable chemical changes in the analysis medium. A small period length leads to just a few ions accumulating on the electrodes 2 during a half-period, which distribute themselves in the solution again during the next half-period. A limitation of the voltage amplitude of the voltage generating the electric field, and the coating of the electrodes 2 with suitable materials, for example noble metals, can additionally help to prevent undesirable deposits on the electrodes 2.

Theoretically, the electrode pair 2 and the electromagnet(s) 3 can be connected in series or in parallel, since both fields must be synchronized for a propulsion. Preferably, both field generators are activated, however, with time-correlated (for example synchronous), yet separate signals. The advantages of this are:
a) The electric and magnetic field strength amplitudes can be adjusted independently of each other.
b) Within an oscillation period, different voltage and current patterns can be realized for the two field generators. This can be expedient, for example, so as to take account of inertias of the ions in the analysis medium or so as to achieve a rapid rise in the magnetic field strength despite the inductive component of the coil reactance.
c) A reversal of direction of the ion feed direction can be easily achieved by reversing the polarity of one of the two activation signals.
d) The fields can be activated with a phase angle of, for example, 90°, in order to obtain an agitation movement instead of a forward movement. This is effective, in particular, in the modification of the third illustrative embodiment according to FIG. 3, in which the MHD pump is disposed directly in one or more chambers 8 for manipulation or analysis.

Further advantages lie in the simple controllability of throughput and flow direction. Furthermore, the forward movement is continuous and, once the ion concentration, the geometric channel ratios and the electrical control signals are known, can be predicted without calibration. The principle is hence also suitable for general analytical test superstructures in which a precise controlling of fluidic media or a small dead volume is important. Finally, besides a forward movement, an agitation movement is also possible without further apparative expenditure, through variation of the electrical signal sequence.

If the electrical voltages have rectangular signal forms, then a high average Lorentz force and a high pump throughput are generated.

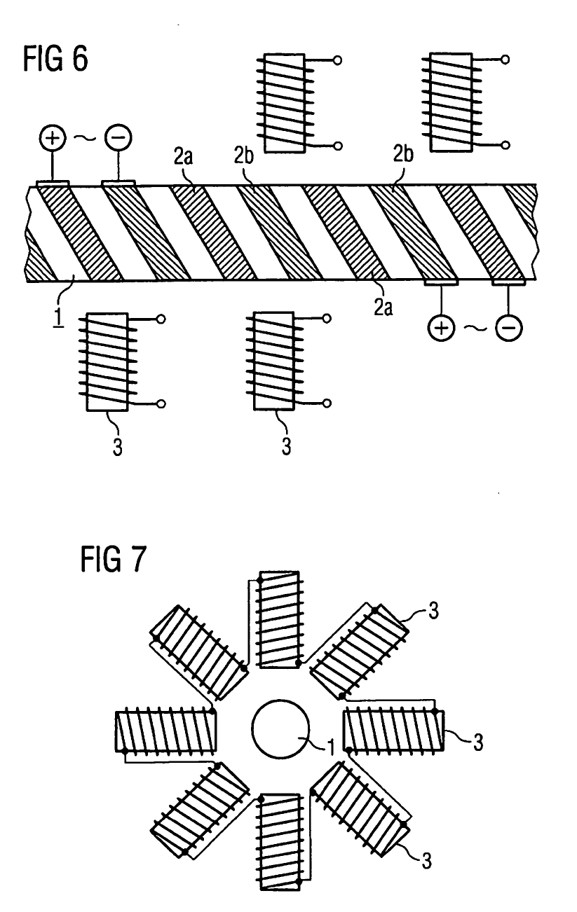

In a fifth illustrative embodiment according to FIGS. 6 and 7, the two electrodes 2a, 2b are not shaped as two parallel rectangles, but are disposed helically around the fluid channel 1. The two electrodes 2a, 2b thus form a double helix. Accordingly, the electromagnets 3 are disposed not only on one or two opposite sides of the fluid channel 1, but form an annular or likewise helical array around this. This arrangement has the advantage that the ions, instead of performing a zigzag-shaped, oscillatory movement, traverse a helical and thus continuous motional path.

The invention is not limited by the disclosed illustrative embodiment, but rather modifications and equivalent embodiments are possible within the scope of the invention as defined by the claims.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A magnetohydrodynamic pump, comprising:
a fluid channel defined in an exchangeable cassette;
an electrode pair to generate an electric field in the fluid channel; and
an electromagnet to generate a magnetic field, the magnetic field lines of which are to intersect electric field lines of the electric field.

2. The magnetohydrodynamic pump as claimed in claim 1, wherein electrical contacts, for at least one of the electrode pair and the electromagnet, are provided on the cassette.

3. The magnetohydrodynamic pump as claimed in claim 2, wherein the electromagnet is disposed outside the exchangeable cassette, the electrode pair is disposed within the exchangeable cassette and the electrode pair is connected to the electrical contacts provided on the exchangeable cassette.

4. The magnetohydrodynamic pump as claimed in claim 1, wherein at least one of the electrode pair and the electromagnet is disposed outside the exchangeable cassette.

5. The magnetohydrodynamic pump as claimed in claim 1, wherein the pump is connected downstream to a fluid chamber containing a fluid.

6. The magnetohydrodynamic pump as claimed in claim 1, wherein the pump is connected upstream to a fluid chamber containing a fluid.

7. The magnetohydrodynamic pump as claimed in claim 5, wherein the fluid chamber has a serpentine continuation in which the fluid is contained.

8. The magnetohydrodynamic pump as claimed in claim 5, wherein the fluid in the fluid chamber is a pumping medium which is in a fluid connection with a fluid to be pumped.

9. The magnetohydrodynamic pump as claimed in claim 1, wherein the pump is disposed in at least one of a manipulation and analysis station.

10. The magnetohydrodynamic pump as claimed in claim 1, wherein the pump is disposed in between two manipulation or analysis stations.

11. The magnetohydrodynamic pump as claimed in claim 1, wherein the electromagnet comprises two coils, between which the fluid channel is disposed.

12. The magnetohydrodynamic pump as claimed in claim 1, further comprising a control device for controlling the electrical voltages applied to the electrode pair and to the electromagnet.

13. The magnetohydrodynamic pump as claimed in claim 12, wherein the electrical voltages have rectangular signal shapes, the control signal for the electromagnet having a strong superelevation of the curve on the rising flank.

14. The magnetohydrodynamic pump as claimed in claim 12, wherein the electrical voltages applied to the electrode pair and to the electromagnet are synchronized.

15. The magnetohydrodynamic pump as claimed in claim 12, wherein the electrical voltages applied to the electrode pair and to the electromagnet are activated separately.

16. The magnetohydrodynamic pump as claimed in claim 12, wherein a phase angle of 90° is present between the electrical voltages applied to the electrode pair and to the electromagnet.

17. The magnetohydrodynamic pump as claimed in claim 1, wherein a single fluid channel is provided in the exchangeable cassette.

18. The magnetohydrodynamic pump as claimed in claim 1, wherein the exchangeable cassette consists of plastic.

19. The magnetohydrodynamic pump as claimed in claim 1, wherein the electrodes form a double helix around the fluid channel, and a plurality of electromagnets are arranged annularly or helically around the fluid channel.

20. The magnetohydrodynamic pump as claimed in claim 6, wherein the fluid chamber has a serpentine continuation in which the fluid is contained.

21. The magnetohydrodynamic pump as claimed in claim 6, wherein the fluid in the fluid chamber is a pumping medium which is in a fluid connection with a fluid to be pumped.

22. The magnetohydrodynamic pump as claimed in claim 7, wherein the fluid in the fluid chamber is a pumping medium which is in a fluid connection with a fluid to be pumped.

23. The magnetohydrodynamic pump as claimed in claim 20, wherein the fluid in the fluid chamber is a pumping medium which is in a fluid connection with a fluid to be pumped.

24. The magnetohydrodynamic pump as claimed in claim 13, wherein the electrical voltages applied to the electrode pair and to the electromagnet are synchronized.

25. The magnetohydrodynamic pump as claimed in claim 13, wherein the electrical voltages applied to the electrode pair and to the electromagnet are activated separately.

26. The magnetohydrodynamic pump as claimed in claim 13, wherein a phase angle of 90° is present between the electrical voltages applied to the electrode pair and to the electromagnet.

27. The magnetohydrodynamic pump as claimed in claim 15, wherein a phase angle of 90° is present between the electrical voltages applied to the electrode pair and to the electromagnet.
